(19) United States
(12) Patent Application Publication
(10) Pub. No.: US 2006/0228529 A1
(43) Pub. Date: Oct. 12, 2006

(54) Discontinuous laminates of polyvinyl butyral or other interlayer material, and laminated glass panes incorporating same

(76) Inventor: Curtis J. Liposcak, Madison, WI (US)

Correspondence Address: Intellectual Property Department;DEWITT ROSS & STEVENS S.C., Suite 401, 8000 Excelsior Drive, Madison, WI, 53717-1914, US

(21) Appl. No.: 11/403,111

(22) Filed: Apr. 12, 2006

Related U.S. Application Data
(60) Provisional application No. 60/670,591, filed on Apr. 12, 2005.

(51) Int. Cl. B32B 3/00

(52) U.S. Cl. 428/189

(57) ABSTRACT

An article of manufacture including a first sheet of interlayer material and a second sheet of interlayer material adhered in face-to-face orientation with the first sheet is described One of the first sheet or the second sheet has at least one void defined therein. A third sheet of interlayer material, of a color different than the first sheet and the second sheet, is disposed within the void. In the preferred version of the invention, the first, second, and third sheets of interlayer material are polyvinyl butyral (PVB).

### CROSS-REFERENCE TO RELATED APPLICATIONS

Priority is hereby claimed to provisional application Ser. No. 60/670,591, filed Apr. 12, 2005, and incorporated herein.

### BACKGROUND

Laminated glass is a conventional and widely used type of glass in the automotive and architectural fields. It is commonly referred to as safety glass. Conventional laminated glass comprises a protective interlayer, usually polyvinyl butyral (PVB), bonded between two panes of glass. The bonding process takes place under heat and pressure. When laminated under these conditions, the PVB interlayer becomes optically clear and binds the two panes of glass together. Once sealed together, the glass “sandwich” (i.e., laminate) behaves as a single unit and looks like normal glass. Annealed, heat-strengthened or tempered glass can be used to produce laminated glass. While laminated glass will crack if struck with sufficient force, the resulting glass fragments tend to adhere to the interlayer rather than falling free and potentially causing injury. In practice, the interlayer provides two extremely beneficial properties to laminated glass panes (among several others): first, the interlayer functions to distribute impact forces across a greater area of the glass panes, thus increasing the impact resistance of the glass; second, the interlayer functions to bind the resulting shards if the glass is ultimately broken. Thus, the benefits of laminated glass include safety, security, sound control, solar energy performance, ultraviolet screening, and (in laminates of sufficiently robust construction) protection from hurricanes, earthquakes and bomb blasts.

PVB has been the dominant interlayer material since the late 1930's. It is currently manufactured and marketed by a number of companies worldwide, including DuPont (Wilmington, Del.) (“Butacite”-brand PVB, introduced in 1938), Solutia (St. Louis, Mo.) (Saflex-brand PVB, introduced in 1940), Kururay Specialties Europe (Frankfort, Germany) (“Trosifol”-brand PVB), and Sekisui (Kyoto, Japan). There are, however, other types of interlayer materials in use, including polyurethanes such as Duraflex-brand thermoplastic polyurethane film, manufactured by Bayer Materials Science, Ludwigschafen, Germany. As used herein, the term “interlayer” refers to any material now known or developed in the future for manufacturing laminated glass. PVB and thermoplastic polyurethanes (TPUs) are explicitly included within the definition of “interlayer.”

The market for laminated glass products is a mature one, and relatively stagnant. For example, with only minor modifications, the PVB interlayer sold today is essentially identical to the PVB sold 30 years ago. Since its introduction in 1938 by DuPont, the worldwide market for PVB interlayer has been dominated by a handful of large chemical concerns (the largest of which are listed in the previous paragraph). As a result, inventive efforts have tended toward methods of making the interlayer itself cheaper to manufacture, or making the interlayer easier to handle and less prone to material defects during the process of fabricating laminated glass panes.

PVB interlayer can be purchased in dyed sheets, such as for the blue “sun strip” at the top edge of many automobile windshields. However, discontinuous laminates of interlayer material that use colored portions of interlayer to form shapes, alpha-numeric indicia, and the like, are heretofore unknown.

### SUMMARY OF THE INVENTION

The invention is directed to an article of manufacture comprising a first sheet of interlayer material and a second sheet of interlayer material adhered in face-to-face orientation with the first sheet. One of the first sheet or the second sheet has at least one void defined therein. A third sheet of interlayer material, of a color different than the first sheet and the second sheet, is disposed within the void. In this fashion, any desired design, of desired color or combination of colors, can be made within the multilayer interlayer. It practice, the interlayer is laminated between two panes of glass. That is, a first pane of glass laminated to the first sheet of interlayer material; and a second pane of glass laminated to the second sheet of interlayer material, preferably under heat and applied pressure. This causes the multilayer interlayer to adhere (preferably permanently) to the glass panes, thereby yielding laminated glass.

The first, second, and/or third sheets of interlayer material preferably comprise polyvinyl butyral (PVB) and/or thermoplastic polyurethane (TPU).

In another version of the invention, a sheet of non-interlayer material is disposed between the first sheet of interlayer material and the second sheet of interlayer material. Preferably, the non-interlayer material comprises polyethylene terephthalate. The resulting multilayer interlayer may be laminated between two panes of glass to yield laminated glass.

### BRIEF DESCRIPTION OF THE FIGURES

FIG. 1A is a cross-sectional schematic depicting a bilayer fabricated from two sheets of interlayer material.

FIG. 1B is a cross-sectional schematic depicting a trilayer fabricated from two sheets of interlayer material 10, sandwiching a central layer 12 of a different type of film.

FIG. 2A is a cross-sectional schematic depicting the bilayer of FIG. 1A with a portion of the upper layer removed.

FIG. 2B is a cross-sectional schematic depicting the trilayer of FIG. 1B with a portion of the upper layer removed.

FIG. 3A is a cross-sectional schematic depicting a discontinuous bilayer interlayer according to the present invention.

FIG. 3B is a cross-sectional schematic depicting a discontinuous trilayer interlayer according to the present invention.

FIG. 4A is a cross-sectional schematic depicting a pane of laminated glass that incorporates the interlayer shown in FIG. 3A.

FIG. 4B is a cross-sectional schematic depicting a pane of laminated glass that incorporates the interlayer shown in FIG. 3B.

FIG. 5A is a cross-sectional schematic depicting the discontinuous bilayer interlayer of FIG. 3A having an additional sheet of interlayer material 16 adhered thereto.

FIG. 5B is a cross-sectional schematic depicting the discontinuous trilayer interlayer of FIG. 3B having an additional sheet of interlayer material 16 adhered thereto.

FIG. 6A is a cross-sectional schematic depicting a pane of laminated glass that incorporates the interlayer shown in FIG. 5A.

FIG. 6B is a cross-sectional schematic depicting a pane of laminated glass that incorporates the interlayer shown in FIG. 3B.

FIG. 7A is a cross-sectional schematic depicting the bilayer of FIG. 2A having two different colored materials disposed within the void in the upper layer, to yield a discontinuous interlayer.

FIG. 7B is a cross-sectional schematic depicting the trilayer of FIG. 2B having two different colored materials disposed within the void in the upper layer, to yield a discontinuous interlayer.

The reference numerals designate the same features throughout all of the drawing figures.

### DETAILED DESCRIPTION OF THE INVENTION

The present invention is directed to discontinuous, multi-layer interlayer constructs, and laminated glass fabricated from the constructs. The invention is best understood by referencing the attached drawings, wherein the reference numerals refer to the same features through all of the various drawings.

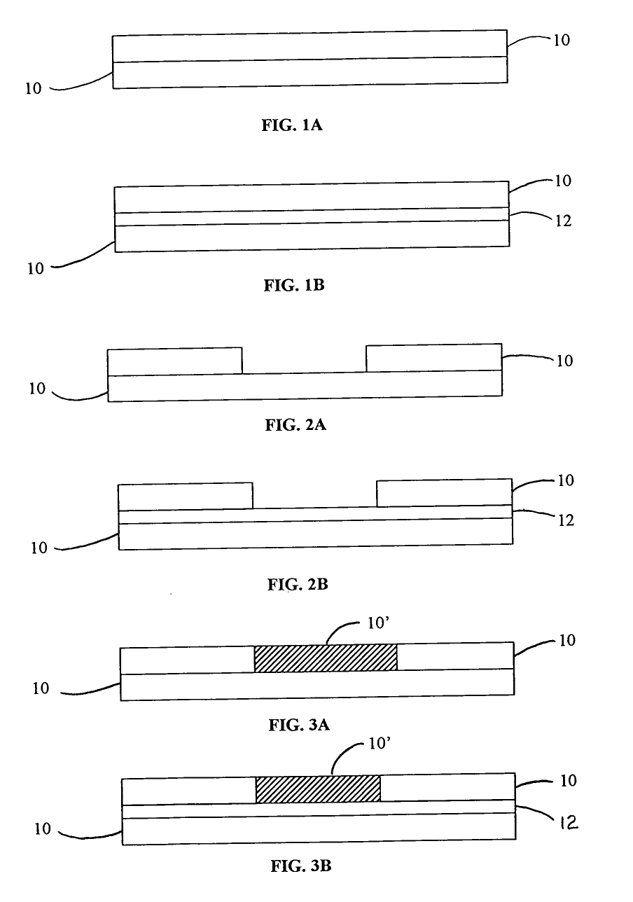

Shown in FIG. 1A is a bilayer formed of two sheets 10 of interlayer material, preferably PVB. Shown in FIG. 1B is a trilayer formed of two sheets of interlayer material 10, sandwiching a central layer 12 of a different type of film, preferably coated polyethylene terephthalate, such as XIR-brand or Heat Mirror-brand film manufactured by Southwall Corporation, Palo Alto, Calif.

As shown in FIGS. 2A and 2B, a discontinuous portion of the upper layer 10 is removed or “weeded out” in a desired shape or pattern. The portion of material removed can take any shape, pattern, or define alpha-numeric indicia, without limitation. As shown in FIGS. 3A and 3B, a piece (or pieces) of colored interlayer material 10′ of a shape that corresponds to the removed portion are fitted into the space where the upper layer 10 was removed. The resulting film is a discontinuous bilayer interlayer (FIG. 3A) or a discontinuous trilayer interlayer (FIG. 3B). By the term “discontinuous” is meant that the uppermost layer in FIGS. 3A and 3B is composed of at least two different types of interlayer material, the material 10 and the material 10′

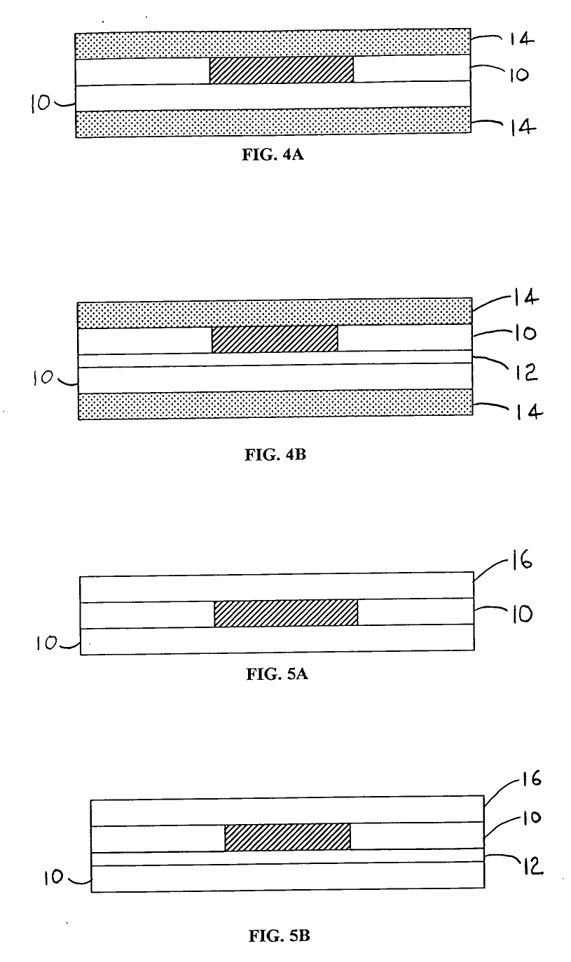

As shown in FIGS. 4A and 4B, the corresponding construct as shown in FIGS. 3A and 3B is then laminated between two plates of glass or other transparent material 14, to yield laminated glass. For purposes of brevity only, the term “glass” shall be used to refer to layer 14 in the figures. As used herein, the term “glass” includes conventional, rigid glass of any chemical composition (silica glass, soda glass, etc) and fabrication technique (sheet glass, float glass, tempered glass, etc), as well as rigid, plastic panes that are transparent to one or more wavelengths of visible light (polycarbonates, polymethylmethacylates, etc.) The glass panes may be flat (as shown in the figures), or curved or otherwise shaped into any desired geometry. Float glass is preferred. The present invention extends to both the interlayer constructions as shown in, for example, FIGS. 3A and 3B, as well as the finished laminated glass product, as shown in FIGS. 4A and 4B.

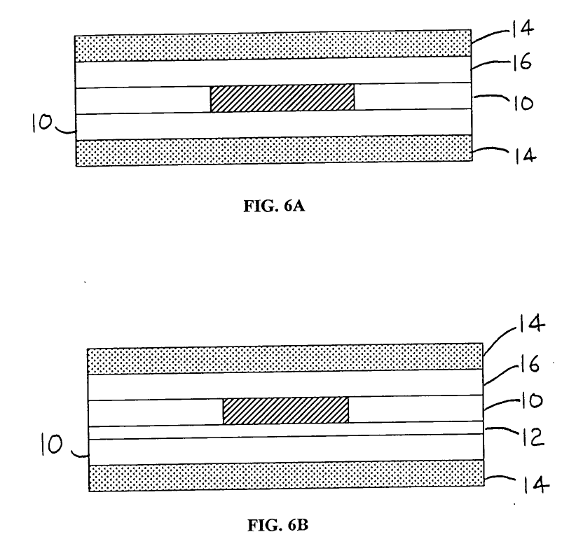

Additional embodiments are shown in FIGS. 5A and 5B. Here, an additional layer of interlayer material 16 is placed on top of the discontinuous layer to form a thicker, more robust interlayer construction. The layer 16 serves to hold the underlying discontinuous layer in place. FIGS. 6A and 6B depict the corresponding laminated glass products that results when using the interlayer constructs shown in FIGS. 5A and 5B, respectively. (The glass panes are designated by reference number 14.)

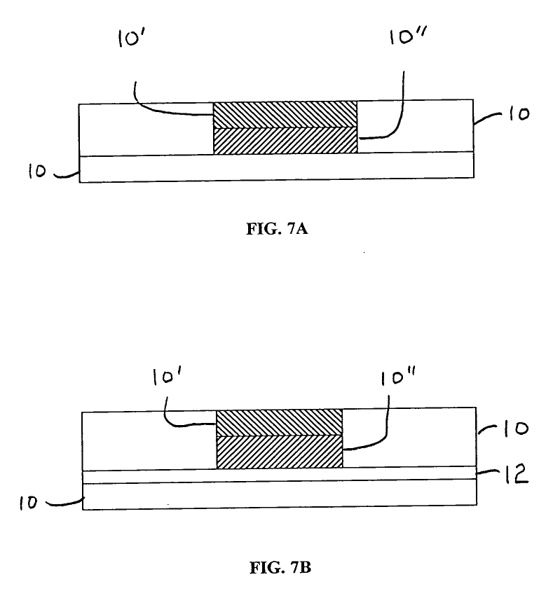

Additionally, to afford maximum design flexibility, the various layers need not be of the same thickness, and various types or colors of interlayer material can be placed within the discontinuities created within upper layer 10, as shown in FIGS. 7A and 7B. Here, after the discontinuity is created, layers 10′ and 10″ are placed within the resulting void. This allows for the creation of complex colors and patterns. As shown in FIGS. 7A and 7B, only two layers of material (10′ and 10″) are shown, but any number of layers (e.g., 10′, 10″, 10′″, etc.) can be placed within the void.

What is claimed is:

1. An article of manufacture comprising:
a first sheet of interlayer material;
a second sheet of interlayer material adhered in face-to-face orientation with the first sheet;
wherein one of the first sheet or the second sheet has at least one void defined therein; and
a third sheet of interlayer material, of a color different than the first sheet and the second sheet, disposed within the void.

2. The article of claim 1, further comprising
a first pane of glass laminated to the first sheet of interlayer material; and
a second pane of glass laminated to the second sheet of interlayer material.

3. The article of claim 1, wherein one of the first sheet of interlayer material or the second layer of interlayer material comprises polyvinyl butyral (PVB).

4. The article of claim 1, wherein the first sheet of interlayer material and the second layer of interlayer material comprise PVB.

5. The article of claim 1, wherein the third sheet of interlayer materials comprises PVB.

6. The article of claim 1, wherein the first sheet of interlayer material, the second layer of interlayer material, and the third sheet of interlayer material comprise PVB.

7. The article of claim 6, further comprising:
a first pane of glass laminated to the first sheet of interlayer material; and
a second pane of glass laminated to the second sheet of interlayer material.

8. The article of claim 1, wherein one of the first sheet of interlayer material or the second layer of interlayer material comprises thermoplastic polyurethane (TPU).

9. The article of claim 1, wherein the first sheet of interlayer material and the second layer of interlayer material comprise TPU.

10. The article of claim 1, wherein the third sheet of interlayer materials comprises TPU.

11. The article of claim 1, wherein the first sheet of interlayer material, the second layer of interlayer material, and the third sheet of interlayer material comprise TPU.

12. The article of claim 11, further comprising:
a first pane of glass laminated to the first sheet of interlayer material; and
a second pane of glass laminated to the second sheet of interlayer material.

13. The article of claim 1, further comprising a sheet of non-interlayer material disposed between the first sheet of interlayer material and the second sheet of interlayer material.

14. The article of claim 13, wherein the sheet of non-interlayer material comprises polyethylene terephthalate.

15. The article of claim 13, further comprising:
a first pane of glass laminated to the first sheet of interlayer material; and
a second pane of glass laminated to the second sheet of interlayer material.

16. An article of manufacture comprising:
a first sheet of PVB;
a second sheet of PVB adhered in face-to-face orientation with the first sheet;
wherein one of the first sheet or the second sheet has at least one void defined therein; and
a third sheet of PVB, of a color different than the first sheet and the second sheet, disposed within the void.

17. The article of claim 16, further comprising:
a first pane of glass laminated to the first sheet of interlayer material; and
a second pane of glass laminated to the second sheet of interlayer material.

18. The article of claim 16, further comprising a sheet of non-PVB material disposed between the first sheet of PVB and the second sheet of PVB.

19. The article of claim 18, further comprising:
a first pane of glass laminated to the first sheet of PVB; and
a second pane of glass laminated to the second sheet of PVB.

20. An article of manufacture comprising:
a first sheet of PVB;
a second sheet of PVB adhered in face-to-face orientation with the first sheet;
wherein one of the first sheet or the second sheet has at least one void defined therein;
a third sheet of PVB, of a color different than the first sheet and the second sheet, disposed within the void;
a first pane of glass laminated to the first sheet of interlayer material; and
a second pane of glass laminated to the second sheet of interlayer material.
